(19) United States
(12) Patent Application Publication
(10) Pub. No.: US 2016/0358039 A1
(43) Pub. Date: Dec. 8, 2016

(54) APPARATUS AND METHOD FOR DETECTING OBJECT

(71) Applicant: Electronics and Telecommunications Research Institute, Daejeon (KR)

(72) Inventors: Jong-Gook KO, Daejeon (KR); Kyoung PARK, Daejeon (KR); Jong-Youl PARK, Daejeon (KR); Joong-Won HWANG, Sejong (KR)

(21) Appl. No.: 15/164,215

(22) Filed: May 25, 2016

(30) Foreign Application Priority Data
Jun. 2, 2015 (KR) 10-2015-0078025

(51) Int. Cl. G06K 9/62; G06K 9/46; G06K 9/48

(52) U.S. Cl. CPC G06K 9/6212; G06K 9/481; G06K 9/4647

(57) ABSTRACT

An apparatus for object detection according to an example includes a level image generating unit configured to generate a plurality of level images with reference to a target image; a feature vector extracting unit configured to extract a feature vector from each level image; a codeword generating unit configured to generate a codeword by clustering the feature vector for each level image; a histogram generating unit configured to generate a histogram corresponding to the codeword; and a classifier configured to generate object recognition information of the target image based on the histogram.

### CROSS REFERENCE TO RELATED APPLICATION

This application claims the benefit under 35 USC §119(a) of Korean Patent Application No. 10-2015-0078025, filed on Jun. 2, 2015, with the Korean Intellectual Property Office, the entire disclosure of which is incorporated herein by reference for all purposes.

### BACKGROUND 1. Field

The following description relates to a technology for detecting objects included in an image, and more particularly to a technology for detecting objects according to feature vector extracted in an image.

2. Description of Related Art

A technology for detecting objects is a technology for automatically recognizing what objects are in an image. Feature extraction such as SIFT (Scale-invariant feature transform) and HOG (Histogram of Oriented Gradients) is used for object detection to analyze edge features of an image.

However, its performance for object recognition is not high enough to accurately detect objects.

Accordingly, technologies using texture-based feature extraction have been developed to increase the performance for object recognition.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an apparatus and method for detecting object may include a level image generating unit configured to generate a plurality of level images with reference to a target image; a feature vector extracting unit configured to extract a feature vector from each level image; a codeword generating unit configured to generate a codeword by clustering the feature vector for each level image; a histogram generating unit configured to generate a histogram corresponding to the codeword; and a classifier configured to generate object recognition information of the target image based on the histogram.

The histogram generating unit may generate a hierarchical histogram by combining histograms corresponding to the codewords for the level images, and the classifier may generate object recognition information of the target image based on the hierarchical histogram.

When a patch with a predetermined size is listed on the level image, the feature vector extracting unit may extract a feature vector of a pixel in each patch.

The feature vector extracting unit may divide the patch into predetermined-sized sub-patches and extract a uniform local binary pattern (ULBP) feature vector for each sub-patch.

The codeword generating unit may cluster the feature vector using a K-means clustering method to classify into one or more clusters, and generate a codeword for each cluster.

The level image generating unit may generate a plurality of level images with reference to a training image, and the classifier may perform training based on the hierarchical histogram corresponding to the training image.

The classifier may be a SVM (support vector machine).

In another general aspect, a method for object detection in which an apparatus for object detection recognizes objects of an image, may include: generating a plurality of level images with reference to a target image; extracting a feature vector from each level image; generating a codeword by clustering the feature vector for each level image; generating a histogram corresponding to the codeword; and generating object recognition information of the target image based on the histogram using a classifier.

The generating a histogram corresponding to the codeword may include generating a hierarchical histogram by combining histograms corresponding to the codewords for the level images, and the generating object recognition information of the target image based on the histogram using a classifier may include generating object recognition information of the target image based on the hierarchical histogram.

The extracting a feature vector from each level image may include, when patches with a predetermined size are listed on the level image, extracting a feature vector of a pixel in each patch.

The extracting a feature vector from each level image may include dividing the patch into predetermined-sized sub-patches and extracting a uniform local binary pattern feature vector for each sub-patch.

The generating a codeword by clustering the feature vector for each level image may include clustering the feature vector using a K-means clustering method to classify into one or more clusters, and generating a codeword for each cluster.

The method may further include generating a plurality of level images with reference to a training image; and performing training based on the hierarchical histogram corresponding to the training image.

The classifier may be a SVM (support vector machine).

An apparatus and a method for object detection according to an example may increase accuracy of object detection of images.

Other features and aspects will be apparent from the following detailed description, the drawings, and the claims.

### BRIEF DESCRIPTION OF THE DRAWINGS

FIG. 1 is a diagram illustrating an example of an apparatus for object detection.

FIG. 2 is a diagram illustrating examples of patches positioned on level images by an apparatus for object detection.

FIG. 3 is a diagram illustrating an example of a process for estimating a feature vector corresponding to a patch by an apparatus for object detection.

FIG. 4 is a diagram illustrating an example for explaining ULBP (Uniform Local Binary Pattern) used by an apparatus for object detection.

FIG. 5 is a diagram illustrating an example of clustering performed by an apparatus for object detection.

FIG. 6 is a diagram illustrating examples of generating hierarchical histograms by an apparatus for object detection.

FIG. 7 is a flowchart illustrating a process for recognizing objects of an image by an apparatus for object detection.

FIG. 8 is a diagram illustrating an example of a computer system in which an apparatus for object detection is implemented.

Throughout the drawings and the detailed description, unless otherwise described or provided, the same drawing reference numerals refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure is thorough, complete, and conveys the full scope of the disclosure to one of ordinary skill in the art.

The terms used herein may be exchangeable to be operated in different directions than shown and described herein under an appropriate environment. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

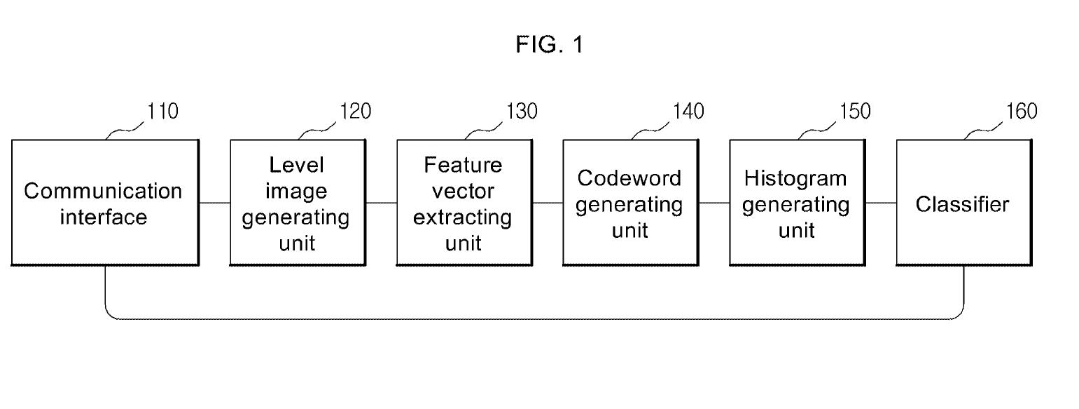

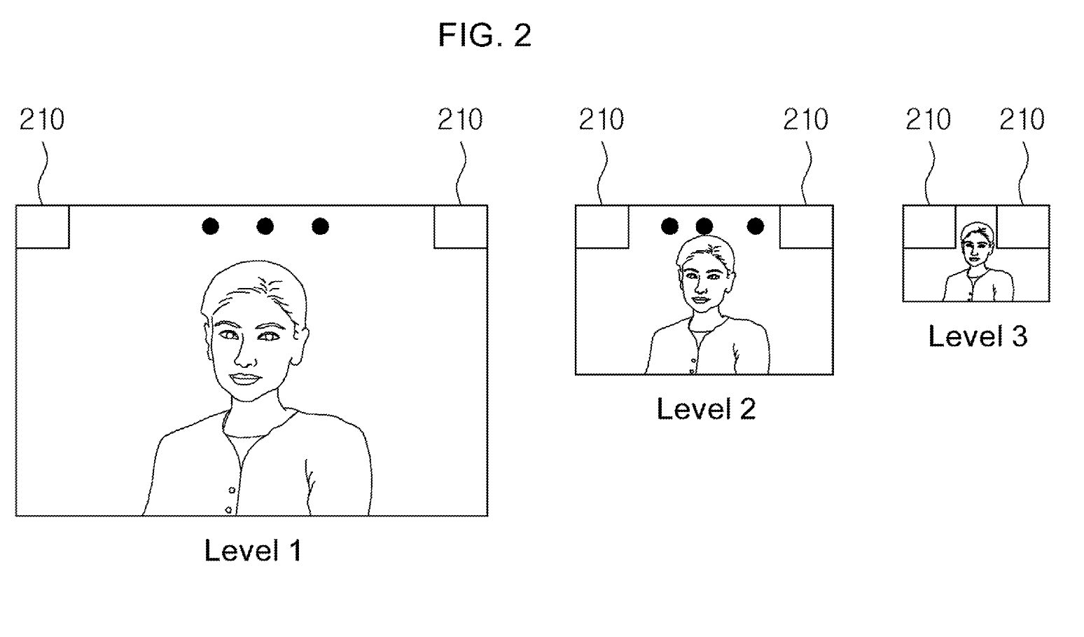

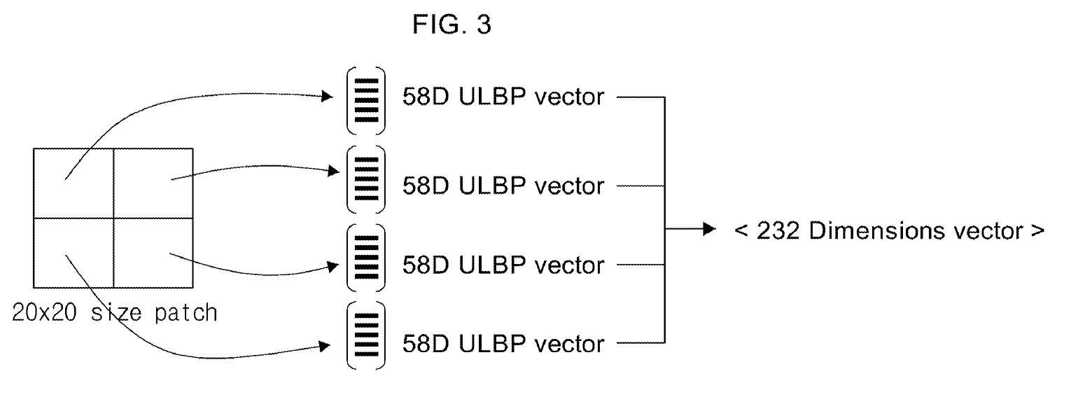

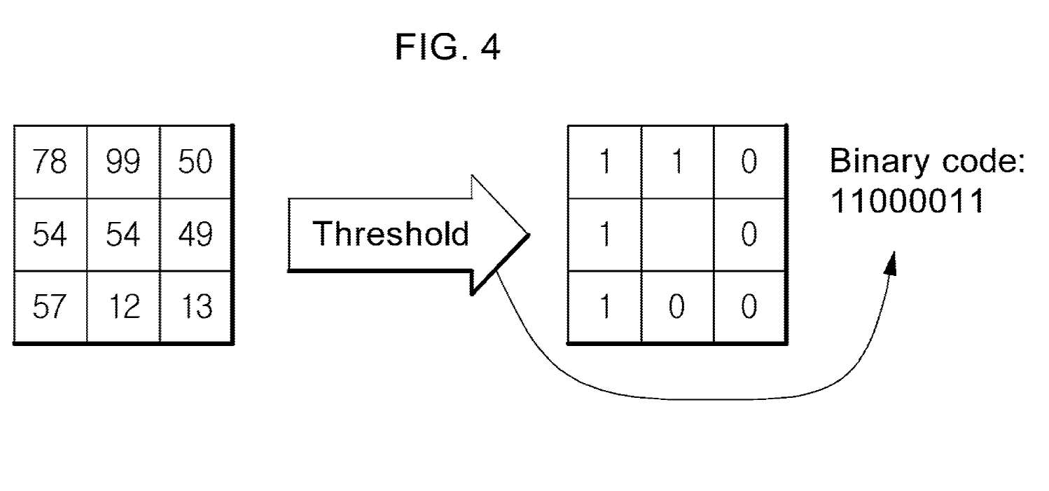

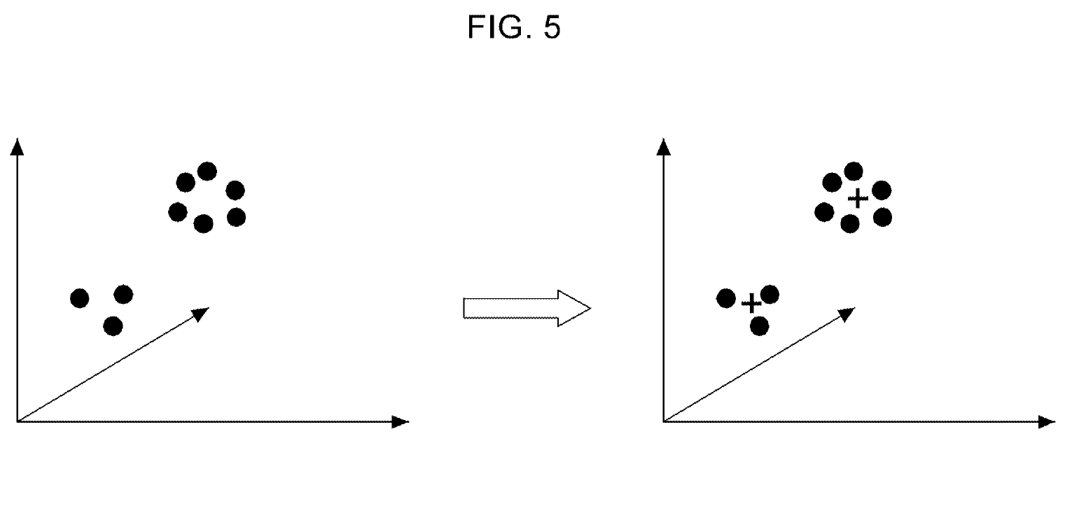

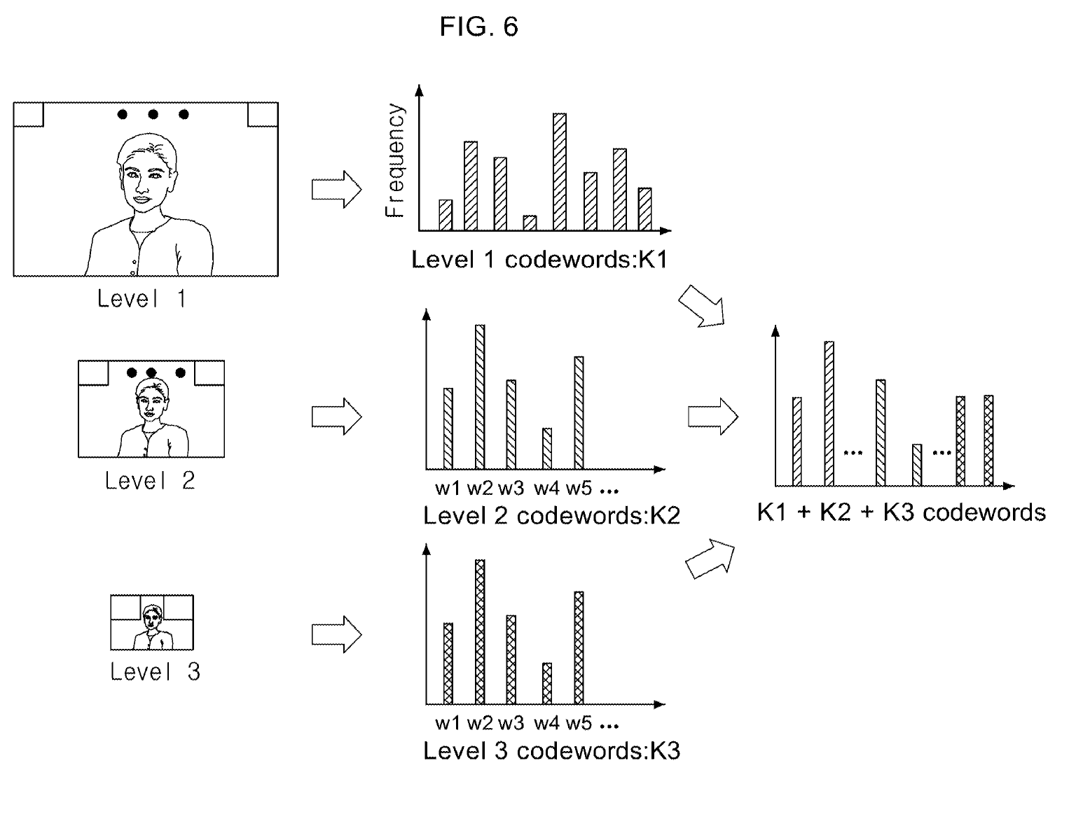

FIG. 1 is a diagram illustrating an example of an apparatus for object detection, FIG. 2 is a diagram illustrating examples of patches positioned on level images by an apparatus for object detection, FIG. 3 is a diagram illustrating an example of a process for estimating a feature vector corresponding to a patch by an apparatus for object detection, FIG. 4 is a diagram illustrating an example for explaining ULBP (Uniform Local Binary Pattern) used by an apparatus for object detection, FIG. 5 is a diagram illustrating an example of clustering performed by an apparatus for object detection, and FIG. 6 is a diagram illustrating examples of generating hierarchical histograms by an apparatus for object detection.

Referring to FIG. 1, an apparatus for object detection according to an example may include a communication interface 110, a level image generating unit 120, a feature vector extracting unit 130, a codeword generating unit 140, a histogram generating unit 150 and a classifier 160.

The communication interface 110 may receive an image from an external device, for example, such as a terminal, a camera, a storage medium and the like. The communication interface 110 may receive an image including a particular object for training a classifier (hereinafter, referred to as training image) or a target image for object detection (hereinafter, referred to as target image). The communication interface 110 may transmit the image to the feature vector extracting unit 130.

The level image generating unit 120 may resize the greater value of width and height of the image to be a predetermined length for each level. Here, the level image generating unit 120 may control a size of the image to maintain a resolution factor of the image (proportion of area to height of the image). The level image generating unit 120 may generate a plurality of images (hereinafter, referred to as level image) of which sizes are controlled to correspond to each level as shown in FIG. 2.

When predetermined-sized patches (for example, 20×20) 210 are positioned on each level image, the feature vector extracting unit 130 may generate a feature vector of a pixel in each patch. Here, the feature vector extracting unit 130 may divide each patch into predetermined-sized sub-patches (for example, 10×10) and extract a uniform local binary pattern feature vector for each sub-patch as shown in FIG. 3. The feature vector extracting unit 130 may combine feature vectors of the sub-patches to estimate a feature vector of the patch. The feature vector extracting unit 130 may generate an 8-digit binary code by comparing a center pixel of each sub-patch to each of 8 surrounding pixels in contact with the center pixel as shown in FIG. 4. The feature vector extracting unit 130 may generate a ULBP feature vector of 58 binary patterns which contain at most two bitwise transitions from 0 to 1 or vice versa from total binary codes. The feature vector extracting unit 130 may generate a feature vector (232 Dimensions) of the patch by combining feature vectors (58 Dimensions) of the sub-patches

The codeword generating unit 140 may generate a codeword for each level image by clustering the feature vectors generated by the feature vector extracting unit 130. For example, the codeword generating unit 140 may cluster the feature vectors into k number of clusters using a K-means clustering method as shown in FIG. 5 wherein k is a natural number of 1 or above. The codeword generating unit 140 may generate a codeword corresponding to the feature vector of each cluster. Thus, the codeword generating unit 140 may generate a codeword corresponding to the feature vector describing each of various edges.

The histogram generating unit 150 may generate a hierarchical histogram which combines histograms of the codewords of all levels as shown in FIG. 6. Here, the histogram may represent the number of feature vectors in the cluster corresponding to each codeword or sum of each predetermined weight corresponding to the distance between a feature vector in the cluster corresponding to each codeword and the center point.

When an image received through the communication interface 110 is a training image, the classifier 160 may learn features of an object according to the hierarchical histogram. For example, the communication interface 110 may receive a training image including a positive image and a negative image and the classifier 160 may perform training using hierarchical histograms for the positive image and the negative image.

When an image received through the communication interface 110 is a target image, the classifier 160 may generate object recognition information describing whether an object corresponding to a codeword is a pre-trained object or not. The classifier 160 may output the object recognition information to an external device through the communication interface 110.

Here, the classifier 160 may be a known classifier, for example, such as a support vector machine (SVM). Detailed explanation for a training process or a process for generating object recognition information by the classifier 160 may be omitted.

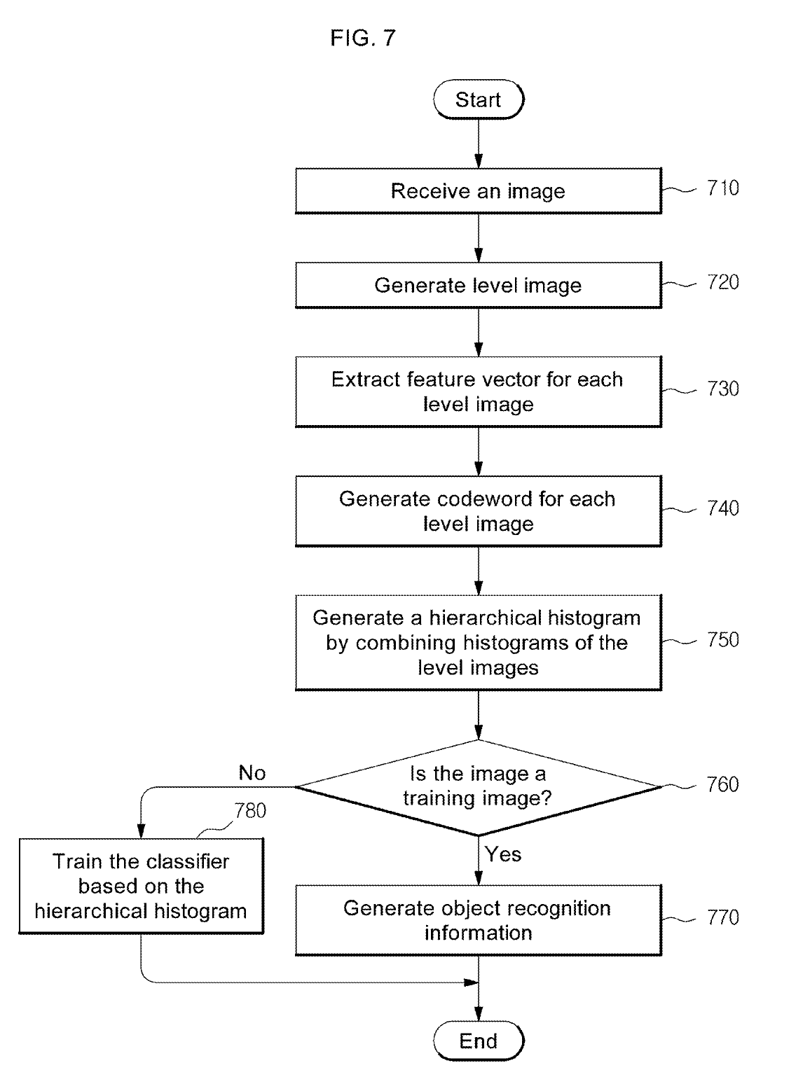

FIG. 7 is a flowchart illustrating a process for recognizing objects of an image by an apparatus for object detection. Each step performed by each unit of an apparatus for object detection according to an example will be explained. Here, a subject of each step will be called as an apparatus for object detection for concise and continent description.

In step 710, an apparatus for object detection may receive an image from an external device. For example, a communication interface 110 may receive a training image for training a classifier or a target image for object recognition.

In step 720, the apparatus for object detection may generate a plurality of level images by resizing the greater value of width and height of the image to be a predetermined length for each level.

In step 730, when predetermined-sized patches (for example, 20×20) 210 are positioned on each level image, the apparatus for object detection may generate feature vectors of pixels in each patch. For example, the apparatus for object detection may divide each patch into predetermined-sized sub-patches (for example, 10×10) and extract a ULBP (uniform local binary pattern) feature vector for each sub-patch. The apparatus for object detection may also combine feature vectors of the sub-patches to estimate a feature vector of the patch

In step 740, the apparatus for object detection may generate a codeword for each level image by clustering the feature vector. For example, the apparatus for object detection may cluster the feature vectors into k number of clusters using a K-means clustering method wherein k is a natural number of 1 or above in order to generate a codeword corresponding to the feature vector in each cluster.

In step 750, the apparatus for object detection may generate a hierarchical histogram by combining histograms of the codewords of the levels.

In step 760, the apparatus for object detection may determine whether the image received in step 710 is a training image or not.

When the image is not a training image, the apparatus for object detection may generate object recognition information describing whether an object corresponding to a codeword is a pre-trained object or not using the trained classifier 160 in step 770.

When the image is a training image, the apparatus for object detection may generate may train the classifier 160 based on the hierarchical histogram in step 780.

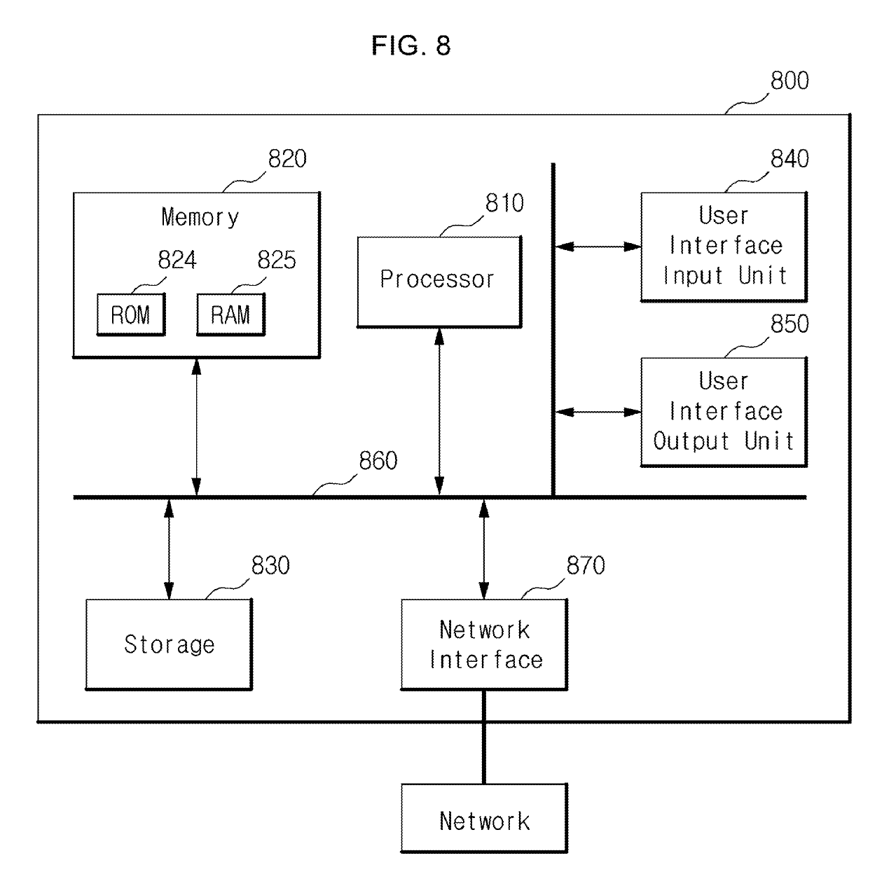

Exemplary embodiments of the present disclosure may be implemented in a computer system, for example, a computer readable recording medium. As shown in FIG. 8, a computer system 800 may include at least one of at least one processor 810, a memory 820, a storing unit 830, a user interface input unit 840 and a user interface output unit 850 in which they may be communicate with each other through a bus 860. The computer system 800 may further include a network interface 870 to connect to a network. The processor 810 may be a CPU or semiconductor device which executes processing commands stored in the memory 820 and/or the storing unit 830. The memory 820 and the storing unit 830 may include various types of volatile/non-volatile storage media. For example, the memory may include ROM 824 and RAM 825.

Accordingly, the exemplary embodiment of the present disclosure can be implemented by the method which the computer is implemented or in non-volatile computer recording media stored in computer executable instructions. The instructions can perform the method according to at least one embodiment of the present disclosure when they are executed by a processor.

What is claimed is:

1. An apparatus for object detection comprising:
a level image generating unit configured to generate a plurality of level images with reference to a target image;
a feature vector extracting unit configured to extract a feature vector from each level image;
a codeword generating unit configured to generate a codeword by clustering the feature vector for each level image;
a histogram generating unit configured to generate a histogram corresponding to the codeword; and
a classifier configured to generate object recognition information of the target image based on the histogram.

2. The apparatus of claim 1, wherein the histogram generating unit generates a hierarchical histogram by combining histograms corresponding to the codewords for the level images, and the classifier generates object recognition information of the target image based on the hierarchical histogram.

3. The apparatus of claim 1, wherein when patches with a predetermined size is listed on the level image, the feature vector extracting unit extracts a feature vector of a pixel in each patch.

4. The apparatus of claim 3, wherein the feature vector extracting unit divides the patch into predetermined-sized sub-patches and extracts a uniform local binary pattern feature vector for each sub-patch.

5. The apparatus of claim 1, wherein the codeword generating unit clusters the feature vector using a K-means clustering method to classify into one or more clusters, and generate a codeword for each cluster.

6. The apparatus of claim 1, wherein the level image generating unit generates a plurality of level images with reference to a training image, and the classifier performs training based on the hierarchical histogram corresponding to the training image.

7. The apparatus of claim 1, wherein the classifier is a support vector machine.

8. A method for object detection in which an apparatus for object detection recognizes objects of an image, the method comprising:
generating a plurality of level images with reference to a target image;
extracting a feature vector from each level image;
generating a codeword by clustering the feature vector for each level image;
generating a histogram corresponding to the codeword; and
generating object recognition information of the target image based on the histogram using a classifier.

9. The method of claim 8, wherein the generating a histogram corresponding to the codeword comprises generating a hierarchical histogram by combining histograms corresponding to the codewords for the level images, and
the generating object recognition information of the target image based on the histogram using a classifier comprises generating object recognition information of the target image based on the hierarchical histogram.

10. The method of claim 8, wherein the extracting a feature vector from each level image comprises, when patches with a predetermined size are listed on the level image, extracting a feature vector of a pixel in each patch.

11. The method of claim 10, wherein the extracting a feature vector from each level image comprises dividing the patch into predetermined-sized sub-patches and extracting a uniform local binary pattern feature vector for each sub-patch.

12. The method of claim 8, wherein the generating a codeword by clustering the feature vector for each level image comprises clustering the feature vector using a K-means clustering method to classify into one or more clusters, and generating a codeword for each cluster.

13. The method of claim 8, further comprising:
generating a plurality of level images with reference to a training image; and
performing training based on the hierarchical histogram corresponding to the training image.

14. The method of claim 8, wherein the classifier is a support vector machine.
